(19) United States
(12) Patent Application Publication
(10) Pub. No.: US 2017/0048034 A1
(43) Pub. Date: Feb. 16, 2017

(54) METHODS AND APPARATUS FOR HE-SIGB ENCODING

(71) Applicant: QUALCOMM Incorporated, San Diego, CA (US)

(72) Inventors: Arjun Bharadwaj, Poway, CA (US); Bin Tian, San Diego, CA (US); Sameer Vermani, San Diego, CA (US)

(21) Appl. No.: 15/231,703

(22) Filed: Aug. 8, 2016

Related U.S. Application Data
(60) Provisional application No. 62/203,351, filed on Aug. 10, 2015.

(51) Int. Cl. H04L 5/00; H04W 72/08; H04W 72/00

(52) U.S. Cl. CPC H04L 5/0044; H04W 72/005; H04W 72/082

(57) ABSTRACT

A method of wirelessly communicating includes generating, at a wireless device, a packet. The method includes generating, for transmission to a plurality of receiving devices, a packet comprising a preamble field, the preamble field comprises a signal (SIG) field. The method further includes encoding a content of a first portion of the SIG field for each channel of a frequency bandwidth, the first portion comprising information for all receiving devices. The method further includes encoding a content of a second portion of the SIG field for each channel of the frequency bandwidth, the second portion comprising one or more codeblocks, the one or more codeblocks including information for each receiving device of the plurality of receiving devices.

### CROSS-REFERENCE TO RELATED APPLICATION INFORMATION

The present application for patent claims priority to Provisional Application No. 62/203,351 entitled “METHODS AND APPARATUS FOR HE-SIGB ENCODING” filed Aug. 10, 2015, which is expressly incorporated by reference herein.

### FIELD

Certain aspects of the present disclosure generally relate to wireless communications, and more particularly, to methods and apparatuses HE-SIGB encoding.

### BACKGROUND

In many telecommunication systems, communications networks are used to exchange messages among several interacting spatially-separated devices. Networks can be classified according to geographic scope, which could be, for example, a metropolitan area, a local area, or a personal area. Such networks can be designated respectively as a wide area network (WAN), metropolitan area network (MAN), local area network (LAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc., frequency bands. Wireless networks advantageously facilitate user mobility and rapid field deployment when compared to fixed wired networks.

As the volume and complexity of information communicated wirelessly between multiple devices continues to increase, overhead frequency bandwidth required for physical layer control signals continues to increase at least linearly. The number of bits utilized to convey physical layer control information has become a significant portion of required overhead. Thus, with limited communication resources, it is desirable to reduce the number of bits required to convey this physical layer control information, especially as multiple types of traffic are concurrently sent from an access point to multiple terminals. At the same time, it is desirable to improve reliability of signal detection. Thus, there is a need for an improved protocol for certain transmissions.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages can become apparent from the description, the drawings, and the claims. Note that the relative dimensions of the following figures may not be drawn to scale.

One aspect provides a method of wirelessly communicating. The method includes generating, for transmission to a plurality of receiving devices, a packet comprising a preamble field, the preamble field comprises a signal (SIG) field. The method further includes encoding a content of a first portion of the SIG field for each channel of a frequency bandwidth, the first portion comprising information for all receiving devices. The method further includes encoding a content of a second portion of the SIG field for each channel of the frequency bandwidth, the second portion comprising one or more codeblocks, the one or more codeblocks including information for each receiving device of the plurality of receiving devices.

Another aspect of the present disclosure provides a method of wirelessly communicating. The method includes generating, for transmission to a plurality of receiving devices, a packet comprising a preamble field, the preamble field comprises a signal (SIG) field. The method further includes encoding a content of a first portion of the SIG field for a first channel of a frequency bandwidth, the first portion comprising information for all receiving devices. The method further includes encoding a content of a second portion of the SIG field for the first channel of the frequency bandwidth, the second portion comprising one or more codeblocks, the one or more codeblocks including information for each receiving device of the plurality of receiving devices, the first portion further comprising an indication of a length of the second portion.

Another aspect of the present disclosure provides a method of wirelessly communicating. The method includes generating, for transmission to a plurality of receiving devices, a packet comprising a preamble field, the preamble field comprises a signal (SIG) field. The method further includes encoding a content of the SIG field for each channel of a frequency bandwidth, the SIG field comprising a first portion comprising information for all receiving devices, a second portion comprising a user field and a cyclic redundancy check (CRC) field for one or more combinations of receiving devices of the plurality of receiving devices.

Another aspect of the present disclosure provides an apparatus for wireless communication. The apparatus includes a processor configured to generate, for transmission to a receiving device, a packet comprising a preamble field, the preamble field comprises a signal (SIG) field. The processor further configured to encode a content of a first portion of the SIG field for each channel of a frequency bandwidth, the first portion comprising information for all receiving devices. The processor further configured to encode a content of a second portion of the SIG field for each channel of the frequency bandwidth, the second portion comprising one or more codeblocks, the one or more codeblocks including information for each receiving device of the plurality of receiving devices.

An additional aspect provides an apparatus for wireless communication. The apparatus comprises means for generating, for transmission to a plurality of receiving devices, a packet comprising a preamble field, the preamble field comprises a signal (SIG) field. The apparatus further comprises means for encoding a content of a first portion of the SIG field for each channel of a frequency bandwidth, the first portion comprising information for all receiving devices. The apparatus further comprises means for encoding a content of a second portion of the SIG field for each channel of the frequency bandwidth, the second portion comprising one or more codeblocks, the one or more codeblocks including information for each receiving device of the plurality of receiving devices.

An additional aspect provides a computer program product comprising a computer readable medium encoded thereon with instructions that when executed cause an apparatus to perform a method of wireless communication. The method comprises generating, for transmission to a plurality of receiving devices, a packet comprising a preamble field, the preamble field comprises a signal (SIG) field. The method further comprises encoding a content of a first portion of the SIG field for each channel of a frequency bandwidth, the first portion comprising information for all receiving devices. The method further comprises encoding a content of a second portion of the SIG field for each channel of the frequency bandwidth, the second portion comprising one or more codeblocks, the one or more codeblocks including information for each receiving device of the plurality of receiving devices.

### BRIEF DESCRIPTION OF THE DRAWINGS

The above-mentioned aspects, as well as other features, aspects, and advantages of the present technology will now be described in connection with various aspects, with reference to the accompanying drawings. The illustrated aspects, however, are merely examples and are not intended to be limiting. Throughout the drawings, similar symbols typically identify similar components, unless context dictates otherwise. Note that the relative dimensions of the following figures may not be drawn to scale.

FIG. 1 illustrates an example of a wireless communication system in which aspects of the present disclosure can be employed.

FIG. 2 illustrates various components that can be utilized in a wireless device that can be employed within the wireless communication system of FIG. 1.

FIG. 3 illustrates an exemplary frame format for the IEEE 802.11ac standard.

FIG. 4 illustrates another exemplary structure of a physical-layer packet which can be used to enable wireless communications.

FIG. 5A illustrates another exemplary structure of a SIGB field.

FIG. 5B illustrates another exemplary structure of a SIGB field.

FIG. 6 illustrates another exemplary structure of a SIGB field over an 80 MHz frequency bandwidth (BW).

FIG. 7 illustrates another exemplary structure for transmitting a SIGB field over an 80 MHz BW to multiple users.

FIG. 8 illustrates another exemplary structure for transmitting a SIGB field over an 80 MHz BW to multiple users using frequency blocks.

FIG. 9 illustrates another exemplary structure for transmitting a SIGB field over an 80 MHz BW to multiple users using a single codeblock.

FIG. 10 is a diagram of various scenarios for channel bonding in an 80 MHz BW.

FIG. 11 is a flowchart of an exemplary method of wireless communication.

### DETAILED DESCRIPTION

Various aspects of the novel systems, apparatuses, and methods are described more fully hereinafter with reference to the accompanying drawings. The teachings disclosed can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies can include various types of wireless local area networks (WLANs). A WLAN can be used to interconnect nearby devices together, employing widely used networking protocols. The various aspects described herein can apply to any communication standard, such as Wi-Fi or, more generally, any member of the IEEE 802.11 family of wireless protocols. For example, the various aspects described herein can be used as part of an IEEE 802.11 protocol, such as an 802.11 protocol which supports orthogonal frequency-division multiple access (OFDMA) communications.

In some aspects, wireless signals can be transmitted according to an 802.11 protocol. In some implementations, a WLAN includes various devices which are the components that access the wireless network. For example, there can be two types of devices: access points (APs) and clients (also referred to as stations, or STAs). In general, an AP can serve as a hub or base station for the WLAN and an STA serves as a user of the WLAN. For example, an STA can be a laptop computer, a personal digital assistant (PDA), a mobile phone, etc. In an example, an STA connects to an AP via a Wi-Fi compliant wireless link to obtain general connectivity to the Internet or to other wide area networks. In some implementations an STA can also be used as an AP.

An access point (AP) can also include, be implemented as, or known as a base station, wireless access point, access node or similar terminology.

A station “STA” can also include, be implemented as, or known as an access terminal (AT), a subscriber station, a subscriber unit, a mobile station, a remote station, a remote terminal, a user terminal, a user agent, a user device, user equipment, or some other terminology. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured for network communication via a wireless medium.

As discussed above, certain of the devices described herein can implement an 802.11 standard, for example. Such devices, whether used as an STA or AP or other device, can be used for smart metering or in a smart grid network. Such devices can provide sensor applications or be used in home automation. The devices can instead or in addition be used in a healthcare context, for example for personal healthcare. They can also be used for surveillance, to enable extended-range Internet connectivity (e.g., for use with hotspots), or to implement machine-to-machine communications.

It can be beneficial to allow multiple devices, such as stations (STAs), to communicate with an access point (AP) at the same time. For example, this can allow multiple STAs to receive a response from the AP in less time, and to be able to transmit and receive data from the AP with less delay. This can also allow an AP to communicate with a larger number of devices overall, and can also make frequency bandwidth usage more efficient. By using multiple access communications, the AP can be able to multiplex orthogonal frequency-division multiplexing (OFDM) symbols to, for example, four devices at once over an 80 MHz frequency bandwidth, where each device utilizes 20 MHz frequency bandwidth. Thus, multiple access can be beneficial in some aspects, as it can allow the AP to make more efficient use of the spectrum available to it.

It has been proposed to implement such multiple access protocols in an OFDM system such as the 802.11 family by assigning different subcarriers (or tones) of symbols transmitted between the AP and the STAs to different STAs. In this way, an AP could communicate with multiple STAs with a single transmitted OFDM symbol, where different tones of the symbol were decoded and processed by different STAs, thus allowing simultaneous data transfer to multiple STAs. These systems are sometimes referred to as OFDMA systems.

Such a tone allocation scheme is referred to herein as a “high-efficiency” (HE) system, and data packets transmitted in such a multiple tone allocation system can be referred to as high-efficiency (HE) packets. Various structures of such packets, including backward compatible preamble fields are described in detail below.

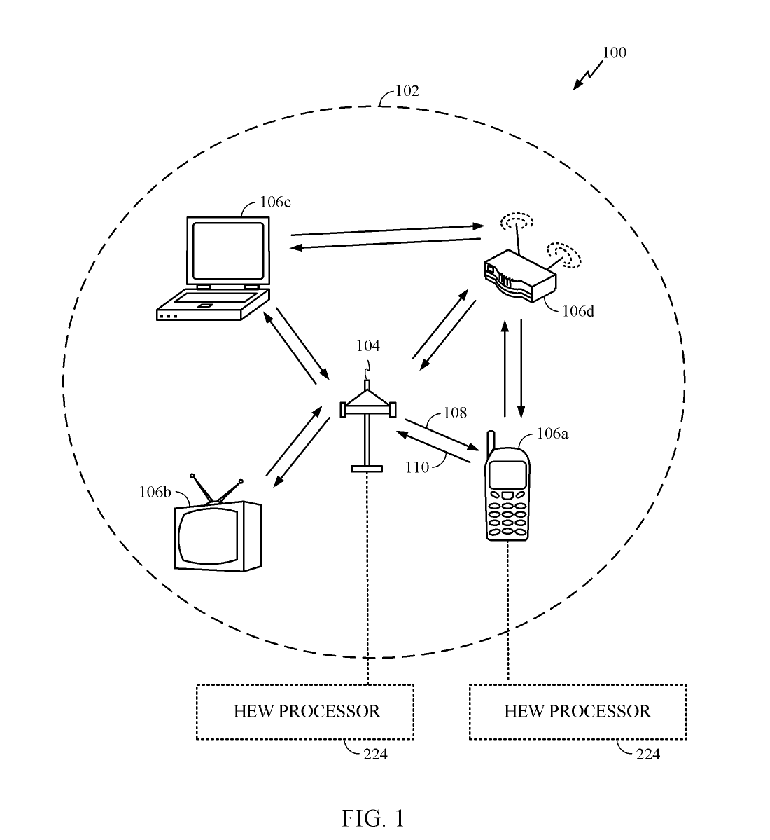

FIG. 1 illustrates an example of a wireless communication system 100 in which aspects of the present disclosure can be employed. The wireless communication system 100 can operate pursuant to a wireless standard, for example at least one of the 802.11ah, 802.11ac, 802.11n, 802.11g, 802.11b, or other/future 802.11 standards. The wireless communication system 100 can operate pursuant to a high-efficiency wireless standard, for example the 802.11ax standard. The wireless communication system 100 can include an AP 104, which communicates with STAs 106A-106D (which can be generically referred to herein as STA(s) 106).

A variety of processes and methods can be used for transmissions in the wireless communication system 100 between the AP 104 and the STAs 106A-106D. For example, signals can be sent and received between the AP 104 and the STAs 106A-106D in accordance with OFDM/OFDMA techniques. If this is the case, the wireless communication system 100 can be referred to as an OFDM/OFDMA system. Alternatively, signals can be sent and received between the AP 104 and the STAs 106A-106D in accordance with code division multiple access (CDMA) techniques. If this is the case, the wireless communication system 100 can be referred to as a CDMA system.

A communication link that facilitates transmission from the AP 104 to one or more of the STAs 106A-106D can be referred to as a downlink (DL) 108, and a communication link that facilitates transmission from one or more of the STAs 106A-106D to the AP 104 can be referred to as an uplink (UL) 110. Alternatively, a downlink 108 can be referred to as a forward link or a forward channel, and an uplink 110 can be referred to as a reverse link or a reverse channel.

The AP 104 can act as a base station and provide wireless communication coverage in a basic service area (BSA) 102. The AP 104 along with the STAs 106A-106D associated with the AP 104 and that use the AP 104 for communication can be referred to as a basic service set (BSS). It can be noted that the wireless communication system 100 may not have a central AP 104, but rather can function as a peer-to-peer network between the STAs 106A-106D. Accordingly, the functions of the AP 104 described herein can alternatively be performed by one or more of the STAs 106A-106D.

In some aspects, a STA 106 can be required to associate with the AP 104 in order to send communications to and/or receive communications from the AP 104. In one aspect, information for associating is included in a broadcast by the AP 104. To receive such a broadcast, the STA 106 can, for example, perform a broad coverage search over a coverage region. A search can also be performed by the STA 106 by sweeping a coverage region in a lighthouse fashion, for example. After receiving the information for associating, the STA 106 can transmit a reference signal, such as an association probe or request, to the AP 104. In some aspects, the AP 104 can use backhaul services, for example, to communicate with a larger network, such as the Internet or a public switched telephone network (PSTN).

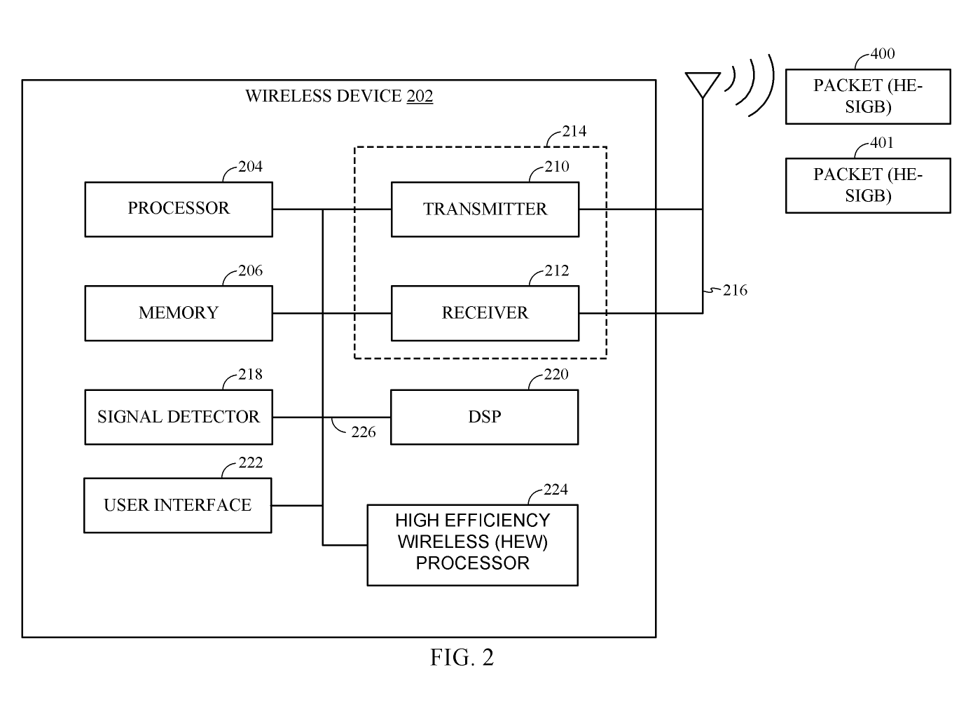

In an embodiment, the AP 104 includes an AP high efficiency wireless processor 224. The AP HEW processor 224 can perform some or all of the operations described herein to enable communications between the AP 104 and the STAs 106A-106D using the 802.11 protocol. The functionality of the AP HEW processor 224 is described in greater detail below with respect to FIGS. 2-5.

Alternatively or in addition, the STAs 106A-106D can include a STA HEW processor 224. The STA HEW processor 224 can perform some or all of the operations described herein to enable communications between the STAs 106A-106D and the AP 104 using the 802.11 protocol. The functionality of the STA HEW processor 224 is described in greater detail below with respect to FIGS. 2-5.

As described above, certain of the devices described herein may implement a high-efficiency 802.11 standard, for example 802.11HEW, 802.11ac, 802.11ax, etc. In some aspects, wireless signals can be transmitted in a low-rate (LR) mode, for example according the 802.11ax protocol. In one aspect, the LR mode may be defined as the modulation and coding scheme (MCS) that has the lowest data rate over a given frequency bandwidth. For example, in the 802.11ax protocol, an MCS10 mode, which is a repeated MCS0 mode (MCS0 mode using binary phase-shift keying (BPSK) modulation and a coding rate of ½), may be defined as a LR mode. In some embodiments, the AP 104 can have a greater transmit power capability compared to the STAs 106. In some embodiments, for example, the STAs 106 can transmit at several dB lower than the AP 104. Thus, DL communications from the AP 104 to the STAs 106 can have a higher range than UL communications from the STAs 106 to the AP 104. In order to close the link budget, the LR mode can be used. In some embodiments, the LR mode can be used in both DL and UL communications. In other embodiments, the LR mode is only used for UL communications.

In some embodiments, the HEW STAs 106 can communicate using a symbol duration four times that of a legacy STA. Accordingly, each symbol which is transmitted may be four times as long in duration. When using a longer symbol duration, each of the individual tones may only require one-quarter as much frequency bandwidth to be transmitted. For example, in various embodiments, a 1× symbol duration can be 4 ms and a 4× symbol duration can be 16 ms. Thus, in various embodiments, 1× symbols can be referred to herein as legacy symbols and 4× symbols can be referred to as HEW symbols. In other embodiments, different durations are possible.

FIG. 2 illustrates various components that can be utilized in a wireless device 202 that can be employed within the wireless communication system 100 of FIG. 1. The wireless device 202 is an example of a device that can be configured to implement the various methods described herein. For example, the wireless device 202 can include the AP 104 or one of the STAs 106A-106D.

The wireless device 202 can include a processor 204 which controls operation of the wireless device 202. The processor 204 can also be referred to as a central processing unit (CPU) or hardware processor. A memory 206, which can include read-only memory (ROM) random access memory (RAM), or both, provides instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include non-transitory machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include multiple transmitters, multiple receivers, multiple transceivers, and/or multiple antennas, which can be utilized during multiple-input multiple-output (MIMO) communications, for example.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a data unit for transmission. In some aspects, the data unit can include a physical layer data unit (PPDU). In some aspects, the PPDU is referred to as a packet.

The wireless device 202 can further include a user interface 222 in some aspects. The user interface 222 can include a keypad, a microphone, a speaker, and/or a display. The user interface 222 can include any element or component that conveys information to a user of the wireless device 202 and/or receives input from the user.

The wireless devices 202 may further comprise a high efficiency wireless (HEW) processor 224 in some aspects. As described herein, the HEW processor 224 may enable APs and/or STAs to generate or encode packets in a low rate (LR) mode or increase protection of LR transmissions from interference by legacy STAs. In various embodiments, the HEW processor 224 can be configured to implement any method, or portion thereof, described herein. As illustrated, antenna 216 may be used to transmit packets with any of the HE-SIGB encoding structures described herein, for example packets 400 and 401 may comprises a HE-SIGB encoding structure 700, 800, or 900 (described in further detail below). In some aspects, determining or transmitting packet formats can allow for efficient use of the wireless medium and reduce overhead.

The various components of the wireless device 202 can be coupled together by a bus system 226. The bus system 226 can include a data bus, for example, as well as a power bus, a control signal bus, and a status signal bus in addition to the data bus. Those of skill in the art can appreciate the components of the wireless device 202 can be coupled together or accept or provide inputs to each other using some other mechanism.

Although a number of separate components are illustrated in FIG. 2, those of skill in the art can recognize that one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

As discussed above, the wireless device 202 can include the AP 104 or one of the STAs 106A-106D, and can be used to transmit and/or receive communications. The communications exchanged between devices in a wireless network can include data units which can include packets or frames. In some aspects, the data units can include data frames, control frames, and/or management frames. Data frames can be used for transmitting data from an AP and/or a STA to other APs and/or STAs. Control frames can be used together with data frames for performing various operations and for reliably delivering data (e.g., acknowledging receipt of data, polling of APs, area-clearing operations, channel acquisition, carrier-sensing maintenance functions, etc.). Management frames can be used for various supervisory functions (e.g., for joining and departing from wireless networks, etc.).

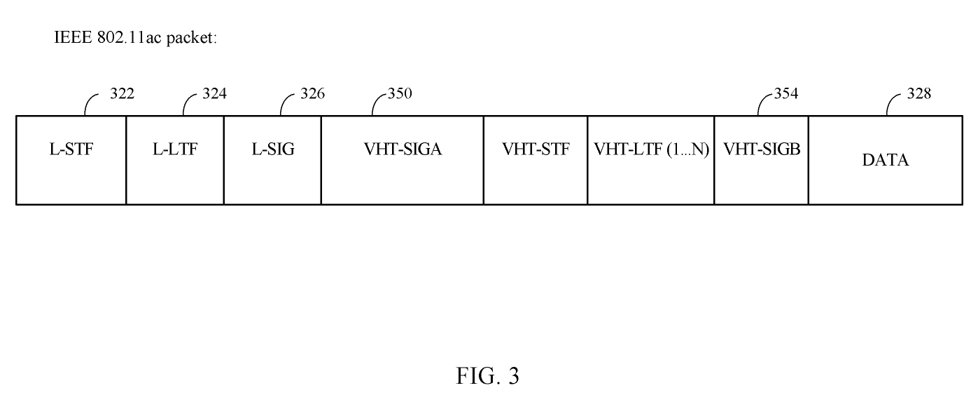

FIG. 3 illustrates a physical-layer packet 300 for the IEEE 802.11ac standard, which added multi-user MIMO functionality to the IEEE 802.11 family. The 802.11ac packet 300 contains a legacy short training field (L-STF) 322, a long training field (L-LTF) 324, and a signal field (L-SIG) field 326. To provide backward compatibility for systems containing both IEEE 802.11a/b/g (etc.) devices and IEEE 802.11ac devices, the data packet for IEEE 802.11ac (and future 802.11) systems also includes the STF, LTF, and SIG fields of these earlier systems, noted as L-STF 322, L-LTF 324, and L-SIG 326 with a prefix L to denote that they are “legacy” fields. When a legacy device configured to operate with IEEE 802.11a/b/g receives such a packet, it can receive and decode the L-SIG field 326 as a normal 11/b/g packet. However, as the device continues decoding additional bits, they might not be decoded successfully because the format of the data packet after the L-SIG field 806 is different from the format of an 11/b/g packet, and the CRC check performed by the device during this process can fail.

The packet 300 also contains a very high throughput (VHT) signal-A (SIGA) field 350. In some aspects, the VHT-SIGA field 350 has two OFDM symbols in length. The VHT-SIGA field 350 may contain information on a frequency bandwidth mode, modulation and coding scheme (MCS) for the single user case, number of space time streams (NSTS), and other information. The VHT-SIGA field 350 can also contain a number of reserved bits that are set to “1.” The legacy fields and the VHT-SIGA field 350 can be duplicated over each 20 MHz of the available frequency bandwidth. Although duplication may be constructed in some implementations to mean making or being an exact copy, certain differences may exist when fields, etc. are duplicated as described herein. For example, other implementations may intentionally duplicate the fields to have certain differences.

After the VHT-SIGA field 350, an 802.11ac packet can contain a VHT-STF, which is configured to improve automatic gain control estimation in a multiple-input and multiple-output (MIMO) transmission. The next 1 to 8 fields of an 802.11ac packet can be VHT-LTFs. These can be used for estimating the MIMO channel and then equalizing the received signal. The number of VHT-LTFs sent can be greater than or equal to the number of spatial streams per user. Finally, the last field in the preamble before the data field is the VHT-SIG-B 354. The VHT-SIG-B 354 may be BPSK modulated, and provide information on the length of the useful data in the packet and, in the case of a multiple user (MU) MIMO packet, provides the MCS. In a single user (SU) case, this MCS information may instead be contained in the VHT-SIGA field 350. Following the VHT-SIG-B 354, the data symbols 328 may be transmitted.

Although 802.11ac introduced a variety of new features to the 802.11 family, and included a data packet with preamble design that was backward compatible with 11/g/n devices and also provided information necessary for implementing the new features of 11ac, configuration information for OFDMA tone allocation for multiple access is not provided by the 11ac data packet design. New preamble configurations are desired to implement such features in any future version of IEEE 802.11 or any other wireless network protocol using OFDM subcarriers.

FIG. 4 is a diagram of an exemplary physical-layer packet 400 including a HE-SIGB field 460. The packet 400 of FIG. 4 is similar to and adapted from packet 300 of FIG. 3 and only differences between packet 300 and 400 are described here for the sake of brevity. In some aspects, FIG. 4 shows the packet structure for an exemplary IEEE 802.11ax packet. In some aspects, an AP 104 or an STA 106 may encode the packet 400 using the AP HEW 224 or STA HEW 224 of FIG. 1 or the HEW processor 224 of FIG. 2. The packet 400 comprises L-STF 322, L-LTF 324, and L-SIG 326 which may be referred to as a legacy preamble 401. The packet 400 further comprises a repeated L-SIG field 440, a HE-SIGA field 450, and a HE-SIGB field 460. As features have been added to IEEE 802.11, changes to the format of the SIG fields in data packets were developed to provide additional information to STAs. For example, information in the HE-SIGB field 460 may contain control information to facilitate decoding of the data 328 of the packet 400. For example, MCS, coding, spatial multiplexing, etc. to enable the receiving STA to decode the data 328. The HE-SIGB field 460 may also provide resource allocation information so that each scheduled STA can decode the data in one or more assigned resource units (RUs). In some embodiments, a RU can be another term for a distinct set of tones allocated to an individual destination STA or device.

A person having ordinary skill in the art will appreciate that the illustrated packet 400 can include additional fields, fields can be rearranged, removed, and/or resized, and the contents of the fields varied. For example, in various embodiments, the HE-SIGB field 460 can further include one or more of: an HE-STF, an HE-LTF, one or more additional HE-SIGB fields, one or more repeated fields, etc.

In the illustrated embodiment, the packet 400 uses a 1× symbol duration. In other embodiments, the 4× symbol duration can be used for at least a portion of the packet 400 such as, for example, any portion of the HE-SIGB 460 and/or the data 328.

In some aspects, the HE-SIGA field 450 may comprise at least 26 bits which may occupy two 1× symbols. In some embodiments, the HE-SIGA field can be repeated in time or in frequency subcarriers (tones). In some aspects, if a device or processor (e.g., HEW processor 224 of FIG. 2) encodes these 26 bit fields in the LR where the HE-SIGA field 450 is repeated, the HE-SIGA field 450 can occupy four 1× symbols (e.g., last approximately 16 μs). It may be desirable when operating in LR mode (e.g., MCS10) to reduce the number of bits in the HE-SIGA field 450 such that it only occupies one 1× symbols and thus, when repeated, would occupy a total of two 1× symbols in the LR mode.

In some embodiments, HE-SIGB field 460 may comprise two portions, a first portion and a second portion. In some aspects, the first portion may be referred to as a common portion which may contain the RU allocation information for all the STAs in a corresponding 20 MHz channel of a frequency bandwidth (BW). In some aspects, the second portion may be referred to as a dedicated portion which may contain per-user information for each STA. In some embodiments, the first portion may be encoded separately than the second portion. In other aspects, the first portion may be encoded together with some or all of the second portion.

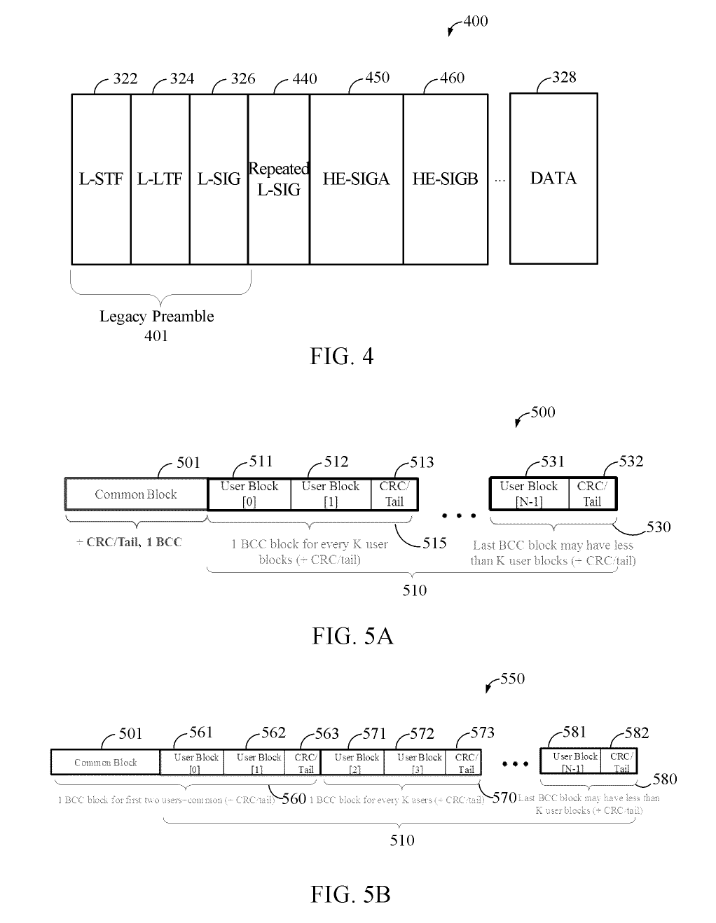

In some embodiments, the HE-SIGB field 460 encoding process is done per 20 MHz and comprises one or more binary convolutional code (BCC) codeblocks or codewords. Each codeblock can be jointly encoded and contains per-user info for ‘k’ users. In some aspects, the boundary between different codeblocks may not necessarily align with OFDM symbol boundaries. The HE-SIGB field 460 encoding structure may be based on one of the following two options as shown in FIGS. 5A and 5B.

FIG. 5A is a diagram of an exemplary HE-SIGB field 500 encoding structure. In some aspects, the HE-SIGB field 500 may comprise an exemplary encoding structure of the HE-SIGB field 460 of FIG. 4. As shown, the common portion or common block 501 is encoded separately in its own BCC codeblock and the dedicated portion 510 is separately encoded in one or more BCC codeblocks for every ‘k’ users. In FIG. 5A, the codeblock 515 comprises user block 511, user block 512, and CRC/Tail portion 513 for encoding information for two users. The codeblock 530 represents the last codeblock in the HE-SIGB field 500 and comprises user block 531 and a CRC/Tail portion 532. In some aspects, the last codeblock in the HE-SIGB field 500 may contain less than the ‘kc’ user blocks that were included in previous codeblocks. While FIG. 5A, illustrates an example where the value of ‘k’ is equal to two users, other values greater than or less than two are also possible.

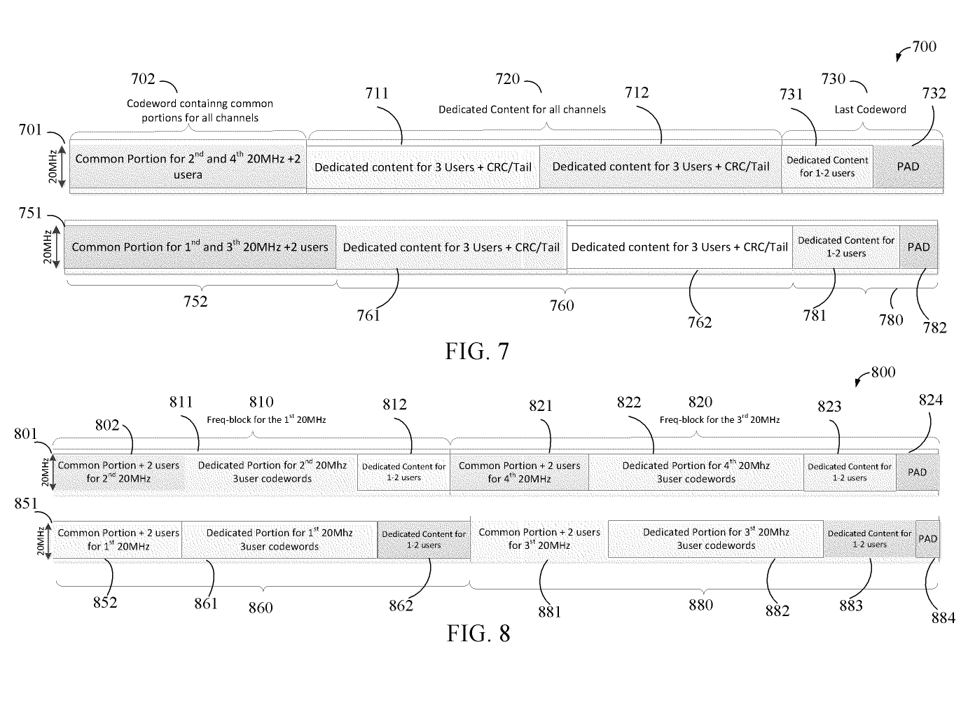

FIG. 5B is a diagram of an exemplary HE-SIGB field 550 encoding structure. In some aspects, the HE-SIGB field 550 may comprise an exemplary encoding structure of the HE-SIGB field 460 of FIG. 4. As shown, the common portion or common block 501 is encoded together with user blocks 561, 562, and CRC/Tail portion 563 in BCC codeblock 560. The remaining portions of the dedicated portion 510 are encoded in one or more BCC codeblocks for every ‘k’ users. In FIG. 5B, the codeblock 570 comprises user block 571, user block 572, and CRC/Tail portion 573 for encoding information for two users. The codeblock 580 represents the last codeblock in the HE-SIGB field 550 and comprises user block 581 and a CRC/Tail portion 582. In some aspects, the last codeblock in the HE-SIGB field 550 may contain less than the ‘k’ user blocks that were included in previous codeblocks. In these embodiments, the last codeblock may also comprise a padding field (e.g., padding field 732, 782 of FIG. 7 discussed below) including additional padding bits such that the duration of the last codeblock is the same as the other codeblocks. These additional padding bits may be located prior to the CRC/Tail portion so that they are also encoded by the transmitter. They may also be placed after the CRC/Tail portion so that they are added after the encoding process at the transmitter. Based on the information in the common portion 501, the receiving STA may discard the padding bits since it knows the actual number of users from the common portion 501. In some embodiments, the last codeblock may contain ‘k’ user blocks and no padding may be necessary. While FIG. 5B, illustrates an example where the value of ‘k’ is equal to two users, other values greater than or less than two are also possible.

In some embodiments, the HE-SIGB encoding structure (e.g., 500 or 550) for BW>=40 MHz requires each STA to decode exactly two 20 MHz carrying different contents (denoted as ½ below). For example, the first 20 MHz may carry the resource allocation and per user information for the STAs for the corresponding 20 MHz data portion (e.g., data portion 328 of FIGS. 3 and 4) and the second 20 MHz may contain scheduling information for the corresponding 20 MHz data portion. Accordingly, each STA receiving the HE-SIGB may need to decode both 20 MHz channels (e.g., the first [primary] 20 MHz and the second [secondary] 20 MHz) to determine its RU allocation.

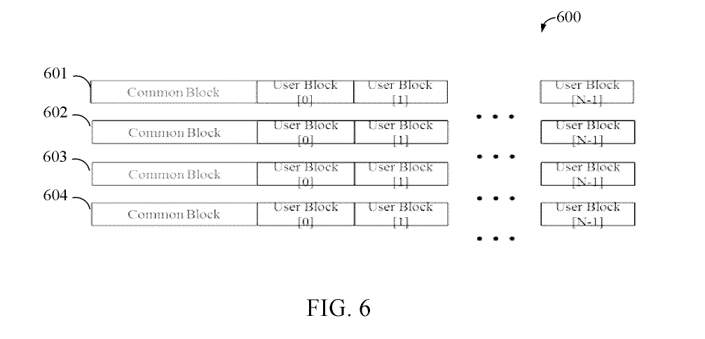

For larger PPDU frequency BWs (e.g., 80 or 160 MHz), each 40 MHz is duplicated and it may be desirable for each STA to decode two 20 MHz channels in order to obtain all the HE-SIGB content. Common and dedicated content for every other 20 MHz channel (1, 3, 5, 7 and 2, 4, 6, 8) may signaled together. For example, FIG. 6 illustrates an exemplary HE-SIGB encoding structure 600 for over an 80 MHz frequency BW. As shown, 20 MHz channel 603 is a duplicate of channel 601 and 20 MHz channel 604 is a duplicate of channel 602. In some aspects, STAs that are allocated into either channel 601 or 603 are signaled together. Similarly, STAs that are allocated into either channel 602 or 604 may be signaled together.

As shown in FIGS. 5A and 5B, in some aspects, multiple BCC codeblock sizes may be needed. The different sizes may be needed because the common portion 501 and dedicated portion 510 may have different codeblock sizes. In some aspects, the common portion 501 and dedicated portion 510 have different amounts of information and may require different size codeblocks to carry such information. Additionally, in some embodiments, content in the common portion 501 increases as a PPDU frequency BW increases. For example, for an 80 MHz frequency BW the common portion may be required to include resource allocation information for the 20 MHz channel (e.g., channels 601 of FIG. 6) and the duplicated 20 MHz channel (e.g., channels 603 of FIG. 6) as described above. Accordingly, the amount of information in the common portion 501 is greater in an 80 MHz frequency BW than a 20 MHz or 40 MHz frequency BW because those frequency BWs do not require duplication. Additionally, in some aspects, the common portion 501 size may also be different for single user (SU) OFDMA and MU-MIMO allocations. For example, MU-MIMO allocations may require RU allocation information for each STA as well as the number of users assigned to each allocation and therefore may have a greater common portion size than a SU ODFMA allocation to include such information.

Additionally, the last codeblock (e.g., codeblock 530 or 580) in an HE-SIGB field may have a different size than previous codeblocks. For example, as shown in FIGS. 5A and 5B, the last codeblocks 530 and 580 contain only one user code block while previous codeblocks contain two user codeblocks, however, other sizes for the last codeblock are also possible.

The different sized codeblocks and other issues regarding HE-SIGB encoding discussed above may be addressed by specifying a HE-SIGB encoding structure that facilitates decoding and reduces packet error rate (PER). In some embodiments, it may be beneficial to segregate common and dedicated portions of the HE-SIGB field. In some aspects, common portions (e.g., common portion 501) for all channels are encoded together in the same codeblock and dedicated portions (e.g., dedicated portion 510) for all channels are grouped into multiple codeblocks.

FIG. 7 is a diagram of a first exemplary HE-SIGB encoding structure 700 for transmitting data over an 80 MHz frequency BW to multiple users. In some aspects, the HE-SIGB encoding structure 700 may comprise an exemplary encoding structure of the HE-SIGB field 460 of FIG. 4. HE-SIGB encoding structure 700 comprises a 20 MHz channel 701 which is transmitted over the 2^{nd} and 4^{th} 20 MHz channels of the 80 MHz frequency BW and a 20 MHz channel 751 which is transmitted over the 1^{st} and 3^{rd} 20 MHz channels of the 80 MHz frequency BW. HE-SIGB encoding structure 700 further comprises a common portion 702, a dedicated portion 720, and a last codeblock 730 for the channel 701. The dedicated portion 720 comprises dedicated content 711 for three users (STAs) and a CRC/Tail portion and dedicated content 712 for the next three users and a CRC/Tail portion. In some aspects, the dedicated content 711 and 712 may comprise user blocks (e.g., user blocks 511, 512 of FIG. 5A) for each of the users in the respective dedicated content blocks. The last code block 730 may comprise dedicated content 731 and padding information 732. In some aspects, the dedicated content 731 may comprise user blocks for each of the users in the dedicated content 731 block. For example, the dedicated content 731 in codeblock 730 may comprise user blocks for one, two, or three users.

HE-SIGB encoding structure 700 similarly comprises a common portion 752, a dedicated portion 760, and a last codeblock 780 for the channel 751. The dedicated portion 760 comprises dedicated content 761 for three users (STAs) and a CRC/Tail portion and dedicated content 762 for the next three users and a CRC/Tail portion. In some aspects, the dedicated content 711 and 712 may comprise user blocks (e.g., user blocks 511, 512 of FIG. 5A) for each of the users in the respective dedicated content blocks. The last code block 780 may comprise dedicated content 781 and padding information 782. In some aspects, the dedicated content 781 may comprise user blocks for each of the users in the dedicated content 781 block. For example, the dedicated content 781 in codeblock 780 may comprise user blocks for one, two, or three users.

In some aspects, the size of common portions 702 and 752 are the same for each 20 MHz. However, in some embodiments, this size may be different based on a PPDU frequency BW size. In some aspects, the PPDU frequency BW size may be indicated in a SIGA field (e.g., HE-SIGA field 450). In some aspects, common portions for SU OFDMA and MU-MIMO may be different which may cause decoding issues for the receiving STAs. In some embodiments, it may be possible to ensure that common portion (e.g., 702 and 752) size is the same for both. However, codeblocks containing common portion and dedicated portions may have different sizes based on the information in the dedicated portions.

Table 1 below illustrates an exemplary number of bits in the common portion for each PPDU frequency BW. As discussed above, the size of the common portion increases as the frequency BW increases (e.g., from 8 or 11 bits to 32 or 44 bits).

TABLE 1

| Common Portion | Option 1 | Option 2 |
|---|---|---|
| 20 MHz | 8 | 11 |
| 40 MHz | 8 | 11 |
| 80 MHz | 16 | 22 |
| 160 MHz | 32 | 44 |

In some embodiments, the dedicated portion for each user (e.g., user blocks 511, 512, 561, 562, etc. in FIGS. 5A and 5B) requires approximately 19 bits. This possible bit allocation may apply to both SU OFDMA and MU-MIMO allocations. In some aspects, the interpretation or definition of each bit for SU OFDMA and MU-MIMO may be different.

For example, Table 2 below illustrates an exemplary allocation of bits in the dedicated portion for an OFDM embodiment. The information in the dedicated portion may include a station (STA) identifier (ID) field to identify the intended recipient of the data. Additionally, the dedicated portion may also include information regarding the spatial multiplexing and modulation of the data. For example, the MCS, the coding, the number of spatial streams (Nss), whether space time block coding (STBC) is used, and whether transmission beamforming (TxBF) is used. Table 2 below shows an exemplary bit allocation for indicating those values which totals 19 for both the STA ID and spatial multiplexing and modulation information.

TABLE 2

| SIGB Dedicated Portion | Number of Bits | Description |
|---|---|---|
| STA ID | 9 | Identification of intended |
| | | recipient |
| Spatial Multiplexing and | 10 | MCS (4 bits), Coding |
| Modulation | | (1 bit), Nss (3 bits), |
| | | STBC (1 bit), TxBF (1 bit) |
| Total | 19 | |

A resource allocation plan for each the users may be defined in the common portion. Ordering of the per-user content may be indicated by mapping RU allocations to users (STAs). For example, the order of the allocation plan may be the same as the decoding order of users in the dedicated portion. Table 3 below shows an exemplary allocation plan included in the common portion and a number of allocations possible for that allocation plan. The allocation shows the number of tones allocated to each user. STAs decoding the dedicated portion may use the allocation plan to determine whether the information in the dedicated portion is intended for them. For example, a STA decoding the dedicated content 711 may find that the STA ID in the dedicated content 711 matches its own STA ID and then can determine from the allocation plan the specific content allocated to the STA.

TABLE 3

| Allocation plan | Number of allocations |
|---|---|
| 9x[1x26] | 1 |
| 1x[2x26] + 7x[1x26] | 4 |
| 2x[2x26] + 5x[1x26] | 6 |
| 3x[2x26] + 3x[1x26] | 4 |
| 4x[2x26] + 1x[1x26] | 1 |
| 1x[1x106] + 5x[1x26] | 2 |
| 1x[1x106] + 1x[2x26] + 3x[1x26] | 4 |
| 1x[1x106] + 2x[2x26] + 1x[1x26] | 2 |
| 2x[1x106] + 1x[1x26] | 1 |
| 1x[1x242] | 1 |
| 1x[1x484] | 1 |
| 1x[1x996] | 1 |
| Total | 28-requires ‘5’ bits |

Table 3 below illustrates an exemplary allocation of bits in the dedicated portion for an MU-MIMO embodiment. As in the OFDM embodiment, the information in the dedicated portion may include a STA ID field to identify the intended recipient of the data. Additionally, the dedicated portion may also include information regarding the number of spatial streams (Nss), the stream index to indicate where the streams start and end, and the spatial multiplexing and modulation of the data. As shown, the MU-MIMO implementation uses the same number of per-user bits as OFDMA, 19. In some aspects, a group identifier (GID) may also be used for MU-MIMO allocations and may be indicated in common portion.

TABLE 4

| SIGB | | |
|---|---|---|
| Dedicated Portion | Number of Bits | Description |
| STA ID | 9 | Identification of intended recipient |
| Nss | 2 | Indicates number of streams |
| | | scheduled |
| Stream Index | 3 | Indicates the index of the first stream. |
| | | Additional streams assigned to the |
| | | user are located by incrementing the |
| | | index |
| Spatial | 5 | MCS (4 bits), Coding (1 bit) |
| Multiplexing and | | |
| Modulation | | |
| Total | 19 | |

Table 4 below illustrates exemplary common portion sizes for different PPDU frequency BWs. The exemplary common portion sizes may apply for both SU OFDMA and MU-MIMO embodiments. As described above, a last codeblock (e.g., codeblock 730) may contain 1-3 users with additional padding (e.g., padding 732, 782) to match a symbol or other boundary. In some embodiments, the additional padding may comprise additional bits to align to a specific codeblock size (e.g., codeblock size of previous codeblocks). In other embodiments, the additional padding may comprise additional bits to align the codeblock size with an OFDM symbol boundary without regard to the codeblock size of the previous codeblocks. For 80 and 1601 MHz, the common bits may be encoded in a separate codeblock given the increased size of the common portion.

TABLE 4

| | Option 1: 8 bits | Option 2: 11 bits | |
|---|---|---|---|
| | Common portion + | Common portion + | Dedicated Portion |
| PPDU BW | 2 users | 2 users | 3 users |
| 40 MHz | 8 + (19 * 2) + 10 = 56 | 11 + (19 * 2) + 10 = 59 | (19 * 3) + 10 = 67 |
| 80 MHz | 16 + (19 * 2) + 10 = 64 | 22 + (19 * 2) + 10 = 70 | |
| 160 MHz | 32 + (19 * 2) + 10 = 80 | 44 + (19 * 2) + 10 = 92 | |

In some embodiments, the length of STA ID field in the HE-SIGB dedicated portion (e.g., dedicated portion 720) may be varied based on the number of active users associated with the basic service set (BSS). For example, if 30 users are active, then they could be addressed with 5 bits instead of the full 9-11 bits, as indicated in Tables 2 and 4. If the number of STA ID bits per user is smaller than 9, more than 3 users can be included into a single codeblock. Since the number of dedicated bits per user would decrease, for example, if 4 bits were used for STA ID, the number of dedicated bits per user would be equal to 10+4=14 bits. In some aspects, four users can be included in one codeblock such that the number of bits included in a codeblock would equal: (4*14)+10=66 bits. For example, with reference to FIG. 7, if the number of bits used for the STA ID field were reduced, the dedicated content 711, 712, 761, and/or 762 may be able to contain user blocks for more than three users (e.g., four users) instead of the three users shown. Accordingly, the codeblock size for the dedicated portion may vary based on the number of bits allocated for STA ID. In some aspects, the number of bits for STA ID may be dynamically allocated.

In a second HE-SIGB encoding structure, the common and dedicated portions for each 20 MHz channel may be grouped together in a sequential structure. The grouped portions may make up a frequency block for a specific 20 MHz channel. FIG. 8 is a diagram of a second exemplary HE-SIGB encoding structure 800 using frequency blocks. In some aspects, the HE-SIGB encoding structure 800 may comprise an exemplary encoding structure of the HE-SIGB field 460 of FIG. 4. HE-SIGB encoding structure 800 comprises a 20 MHz channel 801 which is transmitted over the 2^{nd} and 4^{th} 20 MHz channels of the 80 MHz frequency BW and a 20 MHz channel 851 which is transmitted over the 1^{st} and 3^{rd} 20 MHz channels of the 80 MHz frequency BW. HE-SIGB encoding structure 800 further comprises a frequency block 810 which includes a common portion 802 for the 2^{nd} 20 MHz channel, a dedicated portion 811 for the 2^{nd} 20 MHz channel, and a last codeblock 812 for the 2^{nd} 20 MHz channel. HE-SIGB encoding structure 800 further comprises a frequency block 820 which includes a common portion 821 for the 4^{th} 20 MHz channel, a dedicated portion 822 for the 4^{th} 20 MHz channel, a last codeblock 823 for the 4^{th} 20 MHz channel and optional additional padding 824. As shown, the common portion 802 comprises the common portion plus dedicated content for two users. The dedicated portion 811 comprises dedicated content for three users (STAs) and a CRC/Tail portion, and dedicated portion 812 comprises dedicated content for the last one to three users in the frequency block. In some aspects, the dedicated portions 811 and 812 (and dedicated content included in the common portion 802) may comprise user blocks (e.g., user blocks 511, 512 of FIG. 5A) for each of the users in the respective dedicated content blocks. Similarly, the common portion 821 for the 4^{th} 20 MHz channel includes the common portion plus dedicated content for two users. The dedicated portion 822 comprises dedicated content for three users (STAs) and a CRC/Tail portion, and dedicated portion 823 comprises dedicated content for the last one to three users in the frequency block. Padding 824 comprises additional bits, similar to padding 732 and 782 of FIG. 7 to align the last codeblock size with either previous codeblocks, frequency blocks, or with OFDM symbol boundaries. In some aspects, the dedicated portions 822 and 823 (and dedicated content included in the common portion 821) may comprise user blocks (e.g., user blocks 511, 512 of FIG. 5A) for each of the users in the respective dedicated content blocks.

HE-SIGB encoding structure 800 similarly comprises a frequency block 860 for the 1^{st} 20 MHz channel which includes a common portion 852, a dedicated portion 861, and a last codeblock 862 for the channel 851. HE-SIGB encoding structure 800 further comprises a frequency block 880 for the 3^{rd} 20 MHz channel which includes a common portion 881, a dedicated portion 882, a last codeblock 883, and additional padding 884 for the channel 851. In some aspects, the dedicated portions 861, 862, 882, 883, and the dedicated content in common portions 852 and 881 may comprise user blocks (e.g., user blocks 511, 512 of FIG. 5A) for each of the users in the respective dedicated content blocks. In some embodiments, the size of the common portions 802, 821, 852, and 881 [common portion+2 users] is the same for each frequency-block and is separately encoded. In some aspects, the number of frequency blocks may be determined by the frequency BW indication in SIGA field (e.g., HE-SIGA field 450 of FIG. 4). In some embodiments, it may be possible to ensure that common and dedicated portions have the same size for OFDMA and MU-MIMO allocations. Frequency block boundaries may indicated by the corresponding common portion. Accordingly, each common portion may need to be decoded first before the dedicated portions. For example, the common portion 802 comprises a common portion and the dedicated portion for two users. The common portion contains information on how may dedicated portions or users there are so that the STA decoding the HE-SIGB field can determine the end of the current frequency block 810 and the start of the next frequency block 820. In some aspects, there may be 3 possible codeblock sizes within the frequency blocks. For example, codeblocks containing the common portion, the dedicated portion and/or the last codeblock.

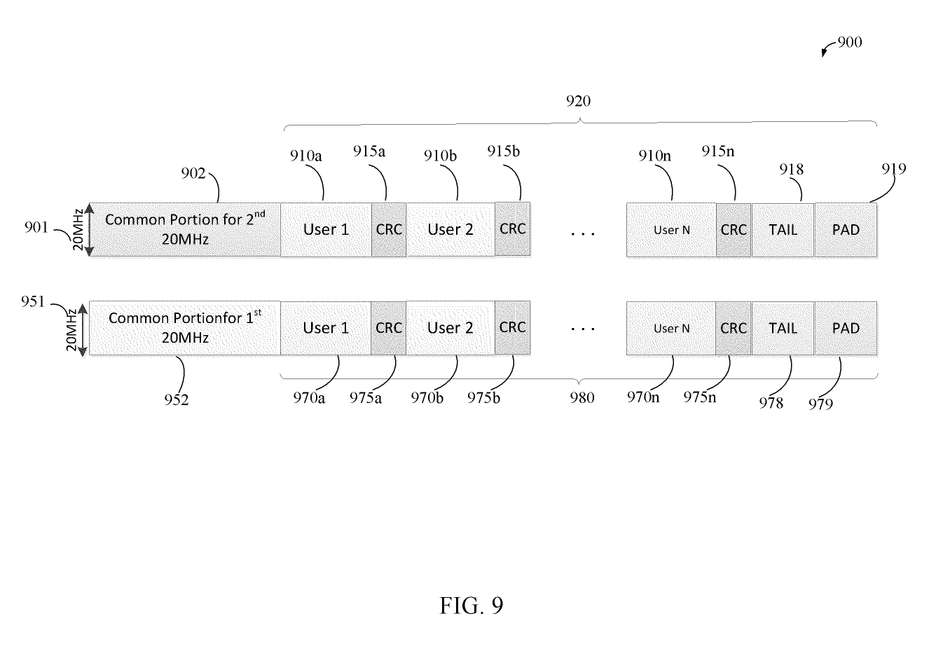

In a third HE-SIGB encoding structure, in each non-duplicated 20 MHz portion of a frequency BW, the common and dedicated portions for all channels may be jointly encoded to form a single codeblock with a CRC applied for each common and per-user information. FIG. 9 is a diagram of a third exemplary HE-SIGB encoding structure 900 using a single codeblock. In some aspects, the HE-SIGB encoding structure 900 may comprise an exemplary encoding structure of the HE-SIGB field 460 of FIG. 4. The HE-SIGB encoding structure 900 comprises a 20 MHz channel 901 which is transmitted over the 2^{nd} 20 MHz channel of an 80 MHz frequency BW and a 20 MHz channel 951 which is transmitted over the 1^{st} 20 MHz channel of the 80 MHz frequency BW. HE-SIGB encoding structure 900 further comprises a common portion 902 for the 2^{nd} 20 MHz channel and a dedicated portion 920 for the 2^{nd} 20 MHz channel. The dedicated portion 920 comprises user blocks 910 for each user (STA) and a corresponding CRC 915 for each user block 910. As shown, the dedicated portion 920 for ‘N’ users comprises user blocks 910a, 910b, up to 910n and corresponding CRCs 915a, 915b to 915n. Similarly, the HE-SIGB encoding structure 900 further comprises a common portion 952 for the 1^{st} 20 MHz channel and a dedicated portion 980 for the 1^{st} 20 MHz channel. The dedicated portion 980 comprises user blocks 970 for each user (STA) and a corresponding CRC 975 for each user block 970. As shown, the dedicated portion 980 for ‘N’ users comprises user blocks 970a, 970b, up to 970n and corresponding CRCs 975a, 975b to 975n. In some embodiments, the HE-SIGB encoding structure 900 may also comprise an additional CRC field after the common portion 902 and 952 and before the user blocks 910a and 970a.

After decoding, a receiving STA parses the common portion 902 and 952 and dedicated portions 920 and 980 and checks CRC for each STA. The individual CRCs for each user block 910 and may help ensure that HE-SIGB performance for each user is comparable to the previous solutions. In some embodiments, additional hardware may needed to buffer more states since the number of OFDM symbols can be up to 16.

In some embodiments, the single codeblock HE-SIGB encoding structure may be used in combination with any of the embodiments described herein. For example, the single codeblock encoding structure may be used in combination with a sequential HE-SIGB encoding structure such as the HE-SIGB encoding structure 800 of FIG. 8. In this embodiment, after the padding 919 in FIG. 9, a separate codeblock on the 20 MHz channel 901 may be encoded for the 4^{th} 20 MHz channel of the exemplary 80 MHz channel (e.g., similar to the sequential structure of frequency blocks 810 and 820 of FIG. 8).

The common portions of the 1st and 3rd 20 MHz channels may also be combined together and the dedicated portions of the 1st and 3rd 20 MHz channels may be combined together as described above. In this case, the CRC after the common portion 902 or 952 may be different depending on the PPDU frequency BW. In other embodiments, all the common portions of all the 20 MHz channels (e.g., 20 MHz channels 601-604 in the 80 MHz frequency BW of FIG. 6) may be encoded together. Additionally, in some aspects, all the dedicated portions/content of all the 20 MHz channels (e.g., 20 MHz channels 601-604 in the 80 MHz frequency BW of FIG. 6) may be encoded together. In these embodiments, since the common portion size would not vary based on the frequency BW, the location of the first CRC would not be different based on the frequency BW.

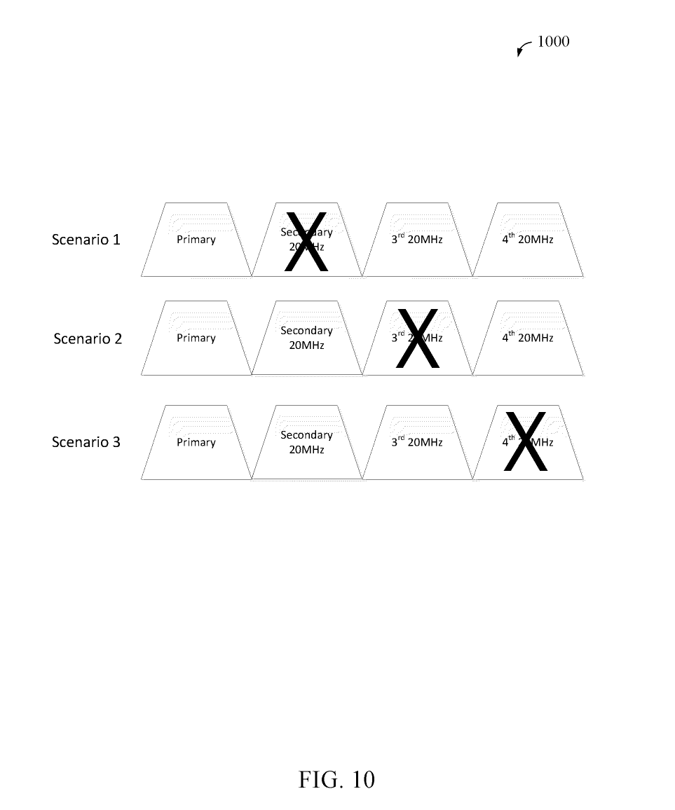

In some embodiments, one or more channels may experience a large amount of interference such that a STA is unable to decode or transmit over the one or more channels. FIG. 10 is a diagram 1000 of different scenarios where one 20 MHz channel of an 80 MHz frequency bandwidth has excessive interference or an interference level and is not capable of communication. The 80 MHz channel comprises a primary, a secondary, third and fourth 20 MHz channel. As shown in FIG. 10 in Scenario 1, the secondary 20 MHz channel is not capable of communication. In Scenario 2, the third 20 MHz channel is not capable of communication. In Scenario 3, the fourth 20 MHz channel is not capable of communication. Additional scenarios are also possible. For example, multiple channels may be incapable of communication (i.e., are punctured).

The embodiment of scenario 1 may have a higher impact to the HE-SIGB because the primary 40 MHz channel cannot be used to decode HE-SIGB field for the whole PPDU frequency BW. Puncturing other 20 Mhz channels (e.g., 3^{rd} and 4^{th}) have smaller impact since HE-SIGB content is reduced on those channels. For example, information for a smaller number of channels may need to be processed by the STA.

In some embodiments, puncturing the second 20 MHz channel may be prohibited. Puncturing only 3^{rd} and 4^{th} 20 MHz bands may be permitted. In some aspects, if there is excessive interference or an interference level in the secondary 20 MHz channel, then the PPDU frequency BW would be reduced to the primary 20 MHz channel

In other embodiments, the receiver STA decodes HE-SIGB in separate 20 MHz channels and not necessarily in the 40 MHz that includes the primary 20 MHz. Which channels to be decoded can be indicated in a variety of ways. For example, channel bonding may be signaled in a SIGA field (e.g., HE-SIGA 450 of FIG. 4). In other aspects, an early bit decoded before the SIGA field may indicate whether the secondary 20 MHz or 4^{th} 20 MHz is to be decoded. Additionally, the number of users in the PPDU frequency BW is not limited in this case. For example, 16 users at MCS0 rate can be supported for each 80 MHz.

In other embodiments to address channel bonding, it may be possible to modify the HE-SIGB structure so that a receiving STA only decodes the primary 40 Mhz. For example, when the second 20 MHz is punctured, all the information may be transmitted in primary 20 MHz channel. In some aspects, transmitting all data over the primary channel may impact the HE-SIGB encoding structure. For example, in the first HE-SIGB encoding structure 700, the size of common portion may be changed and the number of codeblocks may increase. In the second HE-SIGB encoding structure 800, there may be no change to the size of common or dedicated portions but the STAs may need to decode extra 20 MHz frequency blocks. In the third HE-SIGB encoding structure 900, the single codeblock structure size may not be impacted. In this embodiment, the STA needs to parse content based on channel bonding indication. In some aspects, the number of users may be limited if the total number of SIGB symbols is limited to 16 at MCS0 rate.

In some embodiments, the MCS of HE-SIGB may be transmitted at different MCS rates. In some aspects, MCS per 20 MHz is possible (e.g., all common and dedicated portions of a 20 MHz channel have the same MCS). Different 20 MHz channels may have different MCS rates. The specific MCS rate for the 20 MHz channel may be indicated in a SIGA field. In some aspects, the number of MCS bits in the SIGA field is doubled to indicate the different MCS rates.

In some aspects, there may be broadcast/multicast transmissions sent to multiple STAs. In some embodiments, it may be possible to specify a dedicated or common STA ID for transmissions targeted to multiple users. Intended users may be distinguish or determine the transmission is intended for them through the MAC header. For example, if the STA ID for the intended user is located in the MAC header.

In some aspects, there may exist gaps in RU allocations. It may be desirable to specify a dedicated STA ID for RUs that are not allocated. In some embodiments, accounting for all possible gaps in the RU signaling would make the RU allocation table large and not suitable for implementation. In one alternative, it may be possible to have a separate table to identify gaps which may also STAs to skip the gaps. Such an alternative may be more efficient depending on likelihood of gaps in RU allocations.

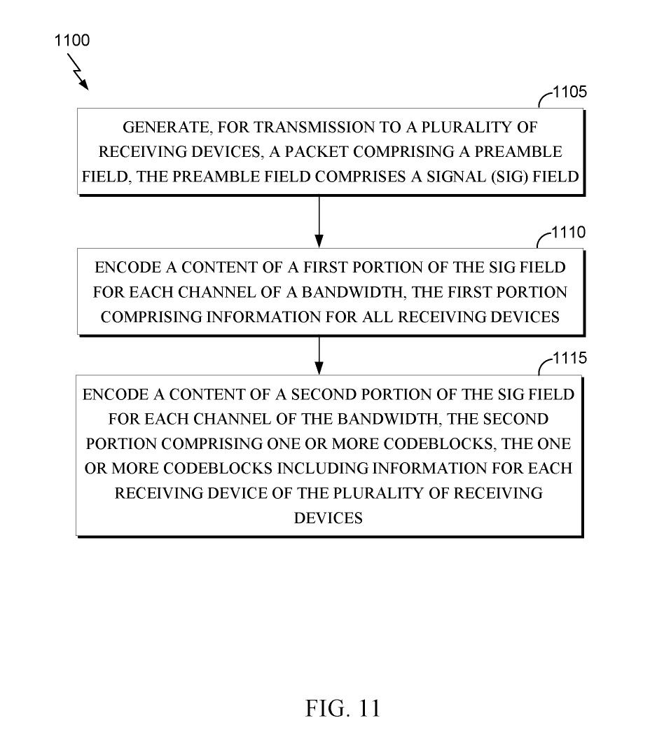

FIG. 11 shows a flowchart 1100 for an exemplary method of wireless communication that can be employed within the wireless communication system 100 of FIG. 1. The method can be implemented in whole or in part by the devices described herein, such as the wireless device 202 shown in FIG. 2. Although the illustrated method is described herein with reference to the wireless communication system 100 discussed above with respect to FIG. 1 and the packets 400 and 401 discussed above with respect to FIGS. 4-5, a person having ordinary skill in the art will appreciate that the illustrated method can be implemented by another device described herein, or any other suitable device (such as the STA 106 and/or the AP 104). Although the illustrated method is described herein with reference to a particular order, in various embodiments, blocks herein can be performed in a different order, or omitted, and additional blocks can be added.

First, at block 1105, a wireless device generates, for transmission to a plurality of receiving devices, a packet comprising a preamble field, the preamble field comprises a signal (SIG) field.

Next, at block 1110, the wireless device encodes a content of a first portion of the SIG field for each channel of a frequency bandwidth, the first portion comprising information for all receiving devices.

Then, at block 1115, the wireless device encodes a content of a second portion of the SIG field for each channel of the frequency bandwidth, the second portion comprising one or more codeblocks, the one or more codeblocks including information for each receiving device of the plurality of receiving devices.

In some embodiments, an apparatus for wireless communication may perform one or more of the functions of method 500, in accordance with certain embodiments described herein. The apparatus may comprise means for means for receiving a signal. In certain embodiments, the means for receiving can be implemented by the receiver 212, the processor 204, the antenna 216, or the attenuator 220 (FIG. 2). In certain selecting, the means for receiving can be configured to perform the functions of block 505 (FIG. 5). The apparatus may comprise means for generating a first attenuated signal based on the received signal. In certain embodiments, the means for generating the first attenuated signal can be implemented by the receiver 212, the processor 204, or the attenuator 220 (FIG. 2). In certain embodiments, the means for generating the first attenuated signal can be configured to perform the functions of block 510 (FIG. 5).

The apparatus may further comprise means for generating for transmission to a plurality of receiving devices, a packet comprising a preamble field, the preamble field comprises a signal (SIG) field. In certain embodiments, the means for generating for transmission to the plurality of receiving devices can be implemented by the transmitter 210, the receiver 212, the processor 204, DSP 220, and/or the HEW processor 224 (FIG. 2). In certain embodiments, the means for generating can be configured to perform the functions of block 1105 (FIG. 11).

The apparatus may further comprise means for encoding a content of a first portion of the SIG field for each channel of a frequency bandwidth, the first portion comprising information for all receiving devices. In certain embodiments, the means for encoding the content of a first portion of the SIG field can be implemented by the transmitter 210, the receiver 212, the processor 204, DSP 220, and/or the HEW processor 224 (FIG. 2). In certain embodiments, the means for encoding the content of a first portion of the SIG field can be configured to perform the functions of block 1110 (FIG. 11).

The apparatus may further comprise means for encoding a content of a second portion of the SIG field for each channel of the frequency bandwidth, the second portion comprising one or more codeblocks. In certain embodiments, the means for encoding the content of a second portion of the SIG field can be implemented by the transmitter 210, the receiver 212, the processor 204, DSP 220, and/or the HEW processor 224 (FIG. 2). In certain embodiments, the means for encoding the content of a second portion of the SIG field can be configured to perform the functions of block 1115 (FIG. 11).

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by a front end or another device or may process information received. In some embodiments, an interface may comprise a transmitter configured to transmit or communicate information or data to another device. Thus, the interface may transmit information or data or may prepare information or data for outputting for transmission (e.g., via a bus).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a frequency bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, aa, bb, cc, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

The various operations of methods described above can be performed by any suitable means capable of performing the operations, such as various hardware and/or software component(s), circuits, and/or module(s). Generally, any operations illustrated in the Figures can be performed by corresponding functional means capable of performing the operations.

The various illustrative logical blocks, modules and circuits described in connection with the present disclosure can be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor can be a microprocessor, but in the alternative, the processor can be any commercially available processor, controller, microcontroller or state machine. A processor can also be implemented as a combination of computing devices, e.g., a combination of a DSP and a microprocessor, a plurality of microprocessors, one or more microprocessors in conjunction with a DSP core, or any other such configuration.

In one or more aspects, the functions described can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium can include non-transitory computer readable medium (e.g., tangible media). In addition, in some aspects computer readable medium can include transitory computer readable medium (e.g., a signal). Combinations of the above can also be included within the scope of computer-readable media.

The methods disclosed herein include one or more steps or actions for achieving the described method. The method steps and/or actions can be interchanged with one another without departing from the scope of the claims. In other words, unless a specific order of steps or actions is specified, the order and/or use of specific steps and/or actions can be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it can be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims

While the foregoing is directed to aspects of the present disclosure, other and further aspects of the disclosure can be devised without departing from the basic scope thereof, and the scope thereof is determined by the claims that follow.

What is claimed is:

1. A method of wireless communication, comprising:
generating, for transmission to a plurality of receiving devices, a packet comprising a preamble field, the preamble field comprises a signal (SIG) field;
encoding a content of a first portion of the SIG field for each channel of a frequency bandwidth, the first portion comprising information for all receiving devices; and
encoding a content of a second portion of the SIG field for each channel of the frequency bandwidth, the second portion comprising one or more codeblocks, the one or more codeblocks including information for each receiving device of the plurality of receiving devices.

2. The method of claim 1, wherein the first portion comprises 8 bits.

3. The method of claim 1, wherein the first portion comprises 11 bits.

4. The method of claim 1, wherein a size of the first portion is based on a size of the frequency bandwidth, i.e., 8 or 11 bits for each channel of a frequency bandwidth.

5. The method of claim 1, wherein the second portion comprises a station identifier (ID) field.

6. The method of claim 5, wherein the station identifier (ID) field comprises 9 or 11 bits.

7. The method of claim 1, wherein the second portion comprises a spatial multiplexing and modulation field.

8. The method of claim 7, wherein the spatial multiplexing and modulation field comprises 10 bits.

9. The method of claim 1, wherein the first portion is encoded separately from encoding the second portion.

10. The method of claim 1, wherein the SIG field further comprises a padding field comprising bits such that a length of a last codeblock of the one or more codeblocks equals a length of another codeblock, and wherein a total length of all the one or more codeblocks in a channel of the frequency bandwidth is the same as a total length of all the one or more codeblocks in another channel.

11. The method of claim 1, wherein the SIG field further comprises a padding field comprising bits such that a length of a last codeblock of the one or more codeblocks aligns with an OFDM symbol boundary.

12. The method of claim 1, further comprising selectively transmitting the packet based on an interference level of a channel of the frequency bandwidth.

13. The method of claim 12, wherein selectively transmitting comprises transmitting the packet on a primary channel of the frequency bandwidth when an interference level of a secondary channel of the frequency bandwidth satisfies a threshold.

14. An apparatus for wireless communication comprising:
a processor configured to,
generate, for transmission to a receiving device, a packet comprising a preamble field, the preamble field comprises a signal (SIG) field,
encode a content of a first portion of the SIG field for each channel of a frequency bandwidth, the first portion comprising information for all receiving devices, and
encode a content of a second portion of the SIG field for each channel of the frequency bandwidth, the second portion comprising one or more codeblocks, the one or more codeblocks including information for each receiving device of the plurality of receiving devices.

15. The apparatus of claim 14, wherein the first portion comprises 8 bits.

16. The apparatus of claim 14, wherein the first portion comprises 11 bits.

17. The apparatus of claim 14, wherein a size of the first portion is based on a size of the frequency bandwidth.

18. The apparatus of claim 14, wherein the second portion comprises a station identifier (ID) field.

19. The apparatus of claim 18, wherein the station identifier (ID) field comprises 9 bits.

20. The apparatus of claim 14, wherein the second portion comprises a spatial multiplexing and modulation field.

21. The apparatus of claim 14, wherein the spatial multiplexing and modulation field comprises 10 bits.

22. The apparatus of claim 14, wherein each of the one or more codeblocks comprises two user blocks.

23. The apparatus of claim 14, wherein the SIG field further comprises a padding field comprising bits such that a length of a last codeblock of the one or more codeblocks equals a length of another codeblock.

24. The apparatus of claim 14, wherein the SIG field further comprises a padding field comprising bits such that a length of a last codeblock of the one or more codeblocks aligns with an OFDM symbol boundary.

25. The apparatus of claim 14, wherein the processor is further configured to selectively transmit the packet based on an interference level of a channel of the frequency bandwidth.

26. The apparatus of claim 25, wherein the processor selectively transmits the packet on a primary channel of the frequency bandwidth when an interference level of a secondary channel of the frequency bandwidth satisfies a threshold.

27. An apparatus for wireless communication comprising:
means for generating, for transmission to a plurality of receiving devices, a packet comprising a preamble field, the preamble field comprises a signal (SIG) field,
means for encoding a content of a first portion of the SIG field for each channel of a frequency bandwidth, the first portion comprising information for all receiving devices; and
means for encoding a content of a second portion of the SIG field for each channel of the frequency bandwidth, the second portion comprising one or more codeblocks, the one or more codeblocks including information for each receiving device of the plurality of receiving devices.

28. A computer program product comprising a computer readable medium encoded thereon with instructions that when executed cause an apparatus to perform a method of wireless communication, the method comprising:
generating, for transmission to a plurality of receiving devices, a packet comprising a preamble field, the preamble field comprises a signal (SIG) field;
encoding a content of a first portion of the SIG field for each channel of a frequency bandwidth, the first portion comprising information for all receiving devices; and
encoding a content of a second portion of the SIG field for each channel of the frequency bandwidth, the second portion comprising one or more codeblocks, the one or more codeblocks including information for each receiving device of the plurality of receiving devices.

29. A method of wireless communication, comprising:
generating, for transmission to a plurality of receiving devices, a packet comprising a preamble field, the preamble field comprises a signal (SIG) field;
encoding a content of a first portion of the SIG field for a first channel of a frequency bandwidth, the first portion comprising information for all receiving devices; and
encoding a content of a second portion of the SIG field for the first channel of the frequency bandwidth, the second portion comprising one or more codeblocks, the one or more codeblocks including information for each receiving device of the plurality of receiving devices, the first portion further comprising an indication of a length of the second portion.

30. The method of claim 29, further comprising:
encoding a content of a third portion of the SIG field for a second channel of the frequency bandwidth, the third portion comprising information for all receiving devices; and
encoding a content of a fourth portion of the SIG field for the second channel of the frequency bandwidth, the fourth portion comprising one or more codeblocks, the one or more codeblocks including information for each receiving device of the plurality of receiving devices, the third portion further comprising an indication of a length of the fourth portion.

31. A method of wireless communication, comprising:
generating, for transmission to a plurality of receiving devices, a packet comprising a preamble field, the preamble field comprises a signal (SIG) field; and
encoding a content of the SIG field for each channel of a frequency bandwidth, the SIG field comprising a first portion comprising information for all receiving devices, a second portion comprising a user field and a cyclic redundancy check (CRC) field for one or more combinations of receiving devices of the plurality of receiving devices.

32. The method of claim 31, wherein encoding the content of the SIG field comprises concurrently encoding the first portion and the second portion.

33. The method of claim 31, wherein the CRC field is different depending on the channel of the frequency bandwidth.
